(19) United States
(12) Patent Application Publication
(10) Pub. No.: US 2025/0045769 A1
(43) Pub. Date: Feb. 6, 2025

(54) COMPUTING SUSTAINABILITY GAINS FOR EQUIPMENT INFRASTRUCTURE

(71) Applicant: Cisco Technology, Inc., San Jose, CA (US)

(72) Inventors: Subramanian Kalpathy Ramachandran, Bangalore (IN); Vivasvan Sudhir Shastri, Bangalore (IN); Srinivasa Sridharamurthy, Bangalore (IN)

(21) Appl. No.: 18/362,102

(22) Filed: Jul. 31, 2023

(51) Int. Cl. G06Q 30/018

(52) U.S. Cl. CPC G06Q 30/018

(57) ABSTRACT

A method comprises: storing vendor device information that maps vendor devices to replacement devices and replacement energies; storing energy provider information that maps unit energy costs to geolocations; obtaining, from a deployed number of units of a device, telemetry records that indicate an energy consumed by, and a geolocation of, the deployed number of units, and information defining an operational configuration of the device; identifying, in the vendor device information, a replacement device and a replacement energy consumed by the replacement device; computing sustainability gains using a replacement number of units of the replacement device in place of the deployed number of units of the device based on the energy consumed, the replacement energy consumed, and the geolocation; determining a change to the operational configuration, and commanding the device to implement the change; and reporting the sustainability gains and the change to the operational configuration.

### TECHNICAL FIELD

The present disclosure relates generally to computing sustainability gains for an equipment infrastructure.

### BACKGROUND

An Environmental, Social, and Business Governance (ESG) score can play a major role for investors in understanding risks and opportunities for an enterprise on the three pillars of ESG. The ESG score gauges sustainability gains made by the enterprise in its efforts to reduce fossil fuel consumption, greenhouse gas emission, and so on. Today, the ESG score is computed based on data made public by the enterprise. Presently, there is no quantitative way to measure the sustainability gain within an enterprise dynamically in an automated way for an information technology (IT) network operation deployed by the enterprise.

### BRIEF DESCRIPTION OF THE DRAWINGS

FIG. 1 is a block diagram of a network environment in which embodiments directed to computing sustainability gains for ESG scoring of an equipment infrastructure may be implemented, according to an example embodiment.

FIG. 2 shows sustainability operations performed by a management entity of the network environment to compute sustainability gains for the equipment infrastructure, according to an example embodiment.

FIG. 3 is a flowchart of a method of performing an assessment of sustainability gains that expands on the sustainability operations of FIG. 2, according to an example embodiment.

FIG. 4 is an equipment master used by the management entity, according to an example embodiment.

FIG. 5 is an energy provider master used by the management entity, according to an example embodiment.

FIG. 6 is an equipment utilization and power consumption table for existing devices deployed in the equipment infrastructure, according to an example embodiment.

FIG. 7 is an equipment utilization and power consumption table for next generation devices recommended to replace devices deployed in the equipment infrastructure, according to an example embodiment.

FIG. 8A is an outcome table that lists computed sustainability outcomes, according to an example embodiment.

FIG. 8B is a table of optimization rules employed to determine and implement a transformation of an operational configuration of the equipment infrastructure to a more energy efficient transformed operational configuration, according to an embodiment.

FIG. 9 is a flowchart of a method of performing an assessment of sustainability gains, according to an example embodiment.

FIG. 10 illustrates a hardware block diagram of a computing device that may perform functions associated with operations discussed herein, according to an example embodiment.

### DETAILED DESCRIPTION

### Overview

In an embodiment, a method comprises: at a management entity configured to communicate with a network: storing vendor device information that maps vendor devices to replacement devices for the vendor devices, and replacement energies consumed by the replacement devices; storing energy provider information that maps unit energy costs to geolocations; obtaining, from a deployed number of units of a device over the network, telemetry records that indicate an energy consumed by, and a geolocation of, the deployed number of units, and information defining an operational configuration of the device; identifying, in the vendor device information, a replacement device for the device and a replacement energy consumed by the replacement device; computing sustainability gains using a replacement number of units of the replacement device in place of the deployed number of units of the device at least based on the energy consumed, the replacement energy consumed, and the geolocation; determining a change to the operational configuration that would result in improved operating energy efficiency, and commanding the device to implement the change; and reporting the sustainability gains and the change to the operational configuration.

### Example Embodiments

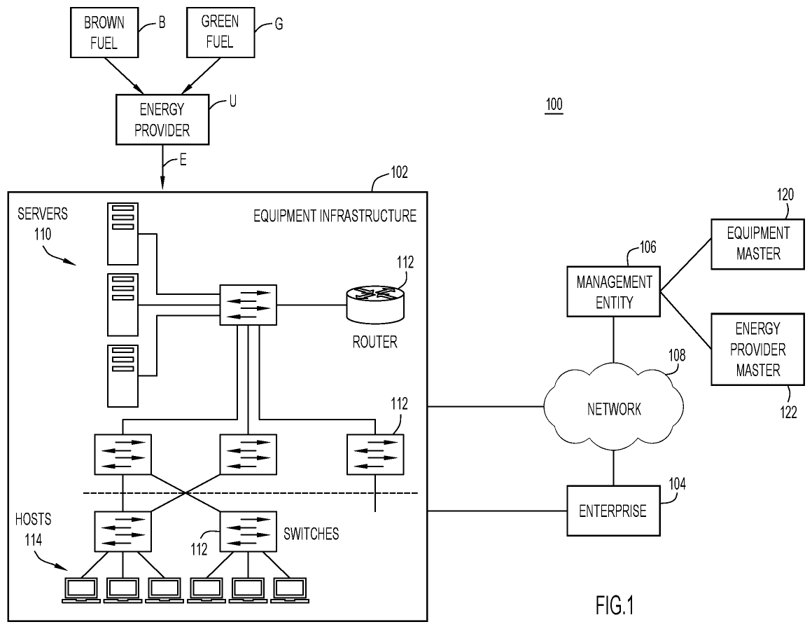

FIG. 1 is a block diagram of an example network environment 100 in which embodiments directed to computing sustainability gains for ESG scoring of an equipment infrastructure may be implemented. Network environment 100 includes equipment infrastructure 102 operated by an enterprise 104, a management entity 106, and a network 108 over which the equipment infrastructure and the management entity communicate with each other. In the example of FIG. 1, an energy provider U (e.g., a power utility) near equipment infrastructure 102 supplies energy E to the equipment infrastructure. Energy utility U may generate the energy from a combination of green fuel G (e.g., solar, wind, and so on) and brown fuel B (e.g., coal, natural gas, and so on). Network 108 may include one or more wide area networks (WANs), such as the Internet, and one or more local area networks (LANs), that convey traffic (e.g., data packets) between equipment infrastructure 102, management entity 106, and enterprise 104 using any known or hereafter developed communication protocols, such as the transmission control protocol (TCP)/Internet Protocol (IP), and the like.

Equipment infrastructure 102 includes a collection of interconnected equipment or devices, such as equipment provided in a data center, network, and so on. The equipment may include hardware devices that provide compute, storage, and network resources in a data center, and/or a network, for example. For example, equipment infrastructure 102 includes servers 110, network devices 112, such as routers and switches, and host devices 114. The individual devices of equipment infrastructure 102 may be co-located at a geographic location (“geolocation”) or may be distributed across multiple spaced-apart geolocations. The devices of equipment infrastructure 102 can communicate with management entity 106 over network 108.

Management entity 106 stores or has access to an equipment master 120 of predetermined vendor device information and an energy provider master 122 of predetermined energy provider information that is available from energy providers (e.g., power utilities). The vendor device information in equipment master 120 lists vendor devices that can be used in equipment infrastructure 102 and maps the vendor devices to (i) their vendor identifying information or “vendor identities” (e.g., model numbers, product types, detailed hardware configurations, and so on), (ii) recommendations of next generation vendor devices (also referred to as “replacement devices”) that are more energy and computationally efficient than the vendor devices and that can be used as replacements for the vendor devices, (iii) energy consumption data for the vendor devices and their replacement devices, (iv) retirement ages for the vendor devices, (v) workload ratios for the vendor devices and their replacements, and so on. The vendor device information may typically include information taken from vendor equipment datasheets. The energy provider information in energy provider master 122 lists energy provider/utilities and maps the energy provider/utilities to (i) their geolocations, (ii) unit energy costs at the geolocations, (iii) proportions or ratios of green fuel to brown fuel used for energy production at the geolocations, and so on.

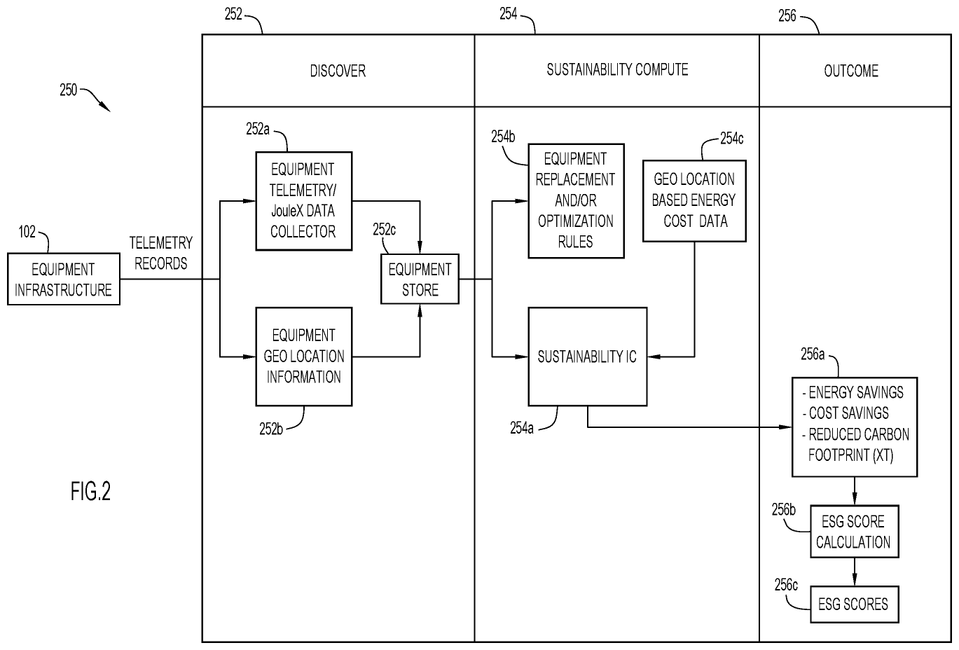

FIG. 2 is an illustration of example sustainability operations 250 performed by management entity 106 to compute (ESG) sustainability gains for equipment infrastructure 102 according to embodiments presented herein. The sustainability gains arise from recommendations to replace devices deployed in equipment infrastructure 102 with more energy and computationally efficient replacement devices corresponding to the devices that are deployed and that are as listed in equipment master 120. To this end, sustainability operations 250 compute sustainability gains that would result from using the recommended replacement devices as quantifiable data on energy consumption reduction (referred to as “reduced energy”), energy cost reduction (referred as “reduced cost”), carbon footprint reduction (referred to as “reduced carbon footprint”), and equipment reduction (also referred to as “reduced equipment”) for equipment infrastructure 102 based on dynamic information retrieved/received from the equipment infrastructure, equipment master 120, and energy provider master 122. Sustainability gains also arise from transforming operational configurations of the deployed devices to more energy efficient transformed operational configurations. To this end, sustainability operations 250 determine changes to transform the operational configurations and compute the sustainability gains that result based on utilization information for the deployed devices and predetermined optimization rules. The quantifiable data may be used to compute or model an ESG score for enterprise 104.

Sustainability operations 250 include a discovery phase 252. During discovery phase 252, management entity 106 establishes one or more connections with equipment infrastructure 102. Equipment infrastructure 102 streams time-stamped telemetry records to management entity 106 over the connections, and the management entity receives/collects the telemetry records from the equipment infrastructure. The telemetry records include a variety of device details for each of devices of equipment infrastructure 102.

At 252a, based on device configuration/identifying information conveyed in the telemetry records, management entity 106 builds a device inventory of the devices of equipment infrastructure 102. The device inventory includes, but is not limited to, for each device:
a. Device type, e.g., router, switch, blade.
b. Product family.
c. Model number or other product identifier. Elements (a), (b), and (c) identify the device and collectively represent device identifying information or device identity.
d. Hardware information, e.g., number of chassis, modules, power supplies, fans, and so on.
e. Geolocation, e.g., location (e.g., Google coordinates) where the device is deployed and operational.
f. Activation date, e.g., a date when the device became active.
g. Current operational configuration (i.e., running configuration) of the device.

At 252b, based on device energy consumption information conveyed in the telemetry records, management entity 106 builds a device energy consumption (i.e., actual energy consumed) inventory of the devices of equipment infrastructure 102. Any known or hereafter developed energy manager may be used to collect the energy consumption information from the devices automatically, and to send the collected energy consumption information to management entity 106 via the telemetry records. For example, the JouleX Energy Manager by Cisco may be used to provide the device energy consumption information. The device energy inventory includes, for each device, a dynamic measurement of the energy consumption and utilization of the device to provide visibility into energy usage. Utilization data may include factors such as whether the device is in-use, offline, spare, central processing unit (CPU) utilization, specifically identified interface/port utilization over a previous 24 hour time period, and so on.

Management entity 106 stores the device inventory and the device energy consumption inventory into an equipment store 252c for access by subsequent operations.

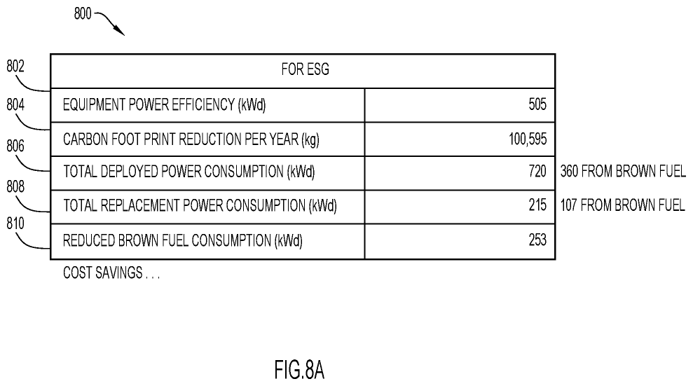

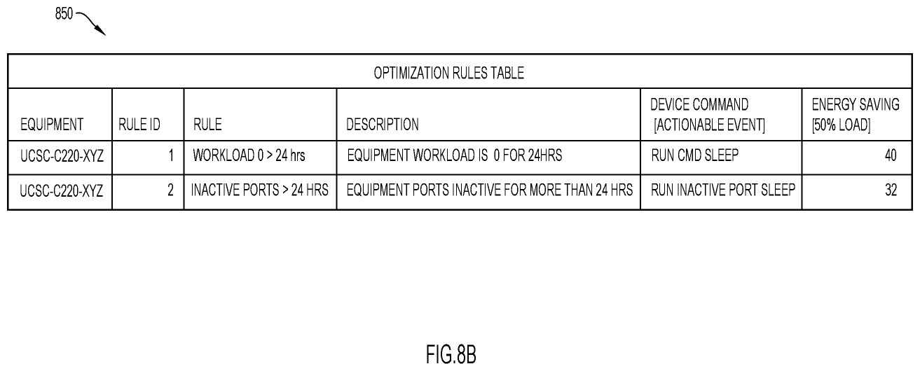

Sustainability operations 250 include a sustainability computation phase 254. At 254a, management entity 106 executes sustainability intellectual Capital (IC) comprising a set of rules and, at 254b, accesses vendor device information from equipment master 120, to compute a reduced energy consumption (referred to more simply as a “reduced energy” or “energy savings”) that can/could be achieved by replacing the devices currently deployed in equipment infrastructure 102 as indicated in the device inventory with next generation (next gen (NG)) devices (i.e., replacement devices) as recommended in the vendor device information. More specifically, the sustainability IC employs:
a. Recommended next gen devices for devices that are deployed in equipment infrastructure 102 and that can be replaced based on ages of retirement indicated in equipment master 120 for the devices as deployed.
b. Potential reduced energy by deploying the next gen devices in place of the devices that are deployed.
c. Additional information related to the devices as deployed, such as device configurations, a number of instances or units of each device that are deployed, deployment constraints, and so on, to achieve equal operational capability using replacement devices. Based on the additional information, including workload ratios, the sustainability IC may compute potential reductions in a number of units of the devices (that are deployed) that may be achieved by replacing the same with fewer numbers of the more computationally efficient next gen devices. For example, 4 units of a deployed device may be replaced by a one next gen device that performs an equivalent workload to the 4 devices that are deployed, based on a 1:4 workload ratio listed in equipment master 120. This is referred to as computing a “reduced quantity” or a “quantity savings” in devices of equipment infrastructure 102.
d. Optimization rules (e.g., as shown in FIG. 8B) by which the sustainability IC determines and implements transformations of operational configurations for the devices as learned from telemetry received from the devices. For example, when the sustainability IC determines that enabled (i.e., fully operating) subsystems (e.g., interfaces/ports) of a particular device are not being utilized based on the operational configuration and the workload data for the particular device, the IC may send to the particular device instructions to place the subsystems into an energy saving or sleep mode (i.e., instructions to disable the subsystems). Even further, the sustainability IC may (i) determine a schedule for time windows of low and high subsystem utilization for the particular device, and (ii) send, to the particular device, instructions that enable and disable the subsystem at times that coincide with the low and high subsystem utilization, respectively. In this way, sustainability gains through operational configuration transformation may be achieved.

At 254c, the sustainability IC accesses energy provider information from energy provider master 122, including unit energy costs per geolocation, and also accesses device geolocations from the telemetry records, to compute a reduced energy cost based on the reduced energy from 254b. In addition, the sustainability IC computes a reduced carbon footprint based on the reduced energy. A carbon footprint is a total amount of greenhouse gases (including carbon dioxide and methane) that is generated from powering equipment infrastructure 102. The carbon footprint may be expressed in terms of a carbon dioxide (CO2) equivalent (CO2e). In an example, a reduced carbon footprint in terms of kg of CO2 may be computed based on the reduced energy supplied to equipment infrastructure 102 by energy utility U according to the following equation: CO2e=reduced energy·emission factor (e.g., 0.85), where the emission factor is captured in the energy provider information and varies between countries.

Sustainability operations 250 include an outcome phase 256. At 256a, management entity 106 outputs or reports the reduced energy (i.e., energy savings), the reduced energy cost (i.e., cost savings), and the reduced carbon footprint computed in sustainability computation phase 254. In addition, management entity 106 may output a report of any operational configuration transformations. At 256b, management entity 106 employs an ESG score calculator to calculate ESG scores 256c based on the reduce energy, the reduced energy costs, and the reduced carbon footprint. In another example in which enterprise 104 hosts the ESC score calculator, management entity 106 provides the above-listed sustainability gains to enterprise 104 over network 108, and then the enterprise computes the ESG scores based on the sustainability gains.

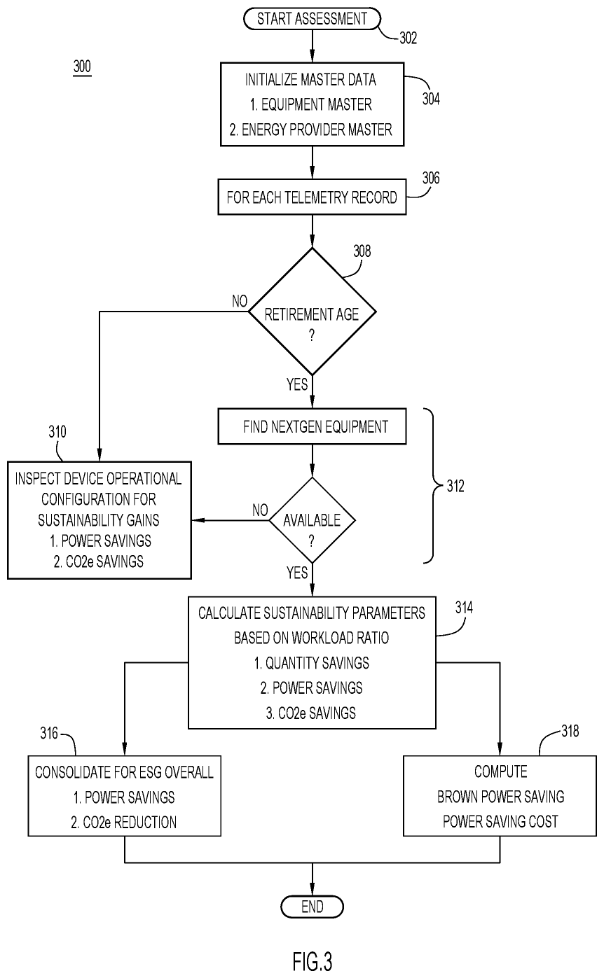

FIG. 3 is a flowchart of an example method 300 of performing an assessment of sustainability that expands on sustainability operations 250 of FIG. 2. The assessment starts at 302 and proceeds to 304. In the ensuing description, a device that is deployed in equipment infrastructure 102 may be referred to as an “existing device” or a “deployed device.” Additionally, a “next gen” device may be referred to as a “replacement device.”

Management entity 106 establishes telemetry feeds to devices of equipment infrastructure 102 over network 108, and provides to the assessment telemetry records received from the devices over the telemetry feeds. At 304, the assessment initializes/configures equipment master 120 with vendor device information described above and configures energy provider master 122 with energy provider information described above.

At 306, the assessment obtains (e.g., receives/accesses) telemetry records from equipment store 252c. In an example, a telemetry record includes an identity for a deployed device (i.e., a device identity) in equipment infrastructure 102 (e.g., one deployed device per telemetry record, or multiple telemetry records per device). The assessment uses the identity carried in the telemetry record as an index to a vendor device in equipment master 120 that has the same (vendor) device identity. In other words, the assessment searches through the device identities of the vendor devices listed in equipment master 120 for a match to the identity of the deployed device as carried in the telemetry record. When a match is found, the match identifies the vendor device that matches the deployed device. Similarly, the assessment uses the geolocation of the deployed device from the telemetry record as an index into energy provider master 122 to identify a unit energy cost for the geolocation, and to find at ratio of green fuel to brown fuel used for energy production at the geolocation.

The assessment repeats next operations 308-318 for each telemetry record/device identified in the telemetry records.

At 308, the assessment accesses a retirement age for the deployed device from equipment master 120, an activation date of the deployed device from the telemetry record, and a current date (e.g., from and online calendar). The assessment determines whether the deployed device is due to retire based on the retirement age, the activation date, and the current date (e.g., whether the elapsed time from the activation date to the current date is greater than the retirement age). When the deployed device is not due to retire, flow proceeds to 310, where the assessment determines and optionally implements a transformed operational configuration for the deployed device, as described below. When the deployed device is due to retire, flow proceeds to 312.

At 310, the assessment inspects the deployed device operational configuration (i.e., running configuration) for possible energy-saving operational configuration settings and sustainability gains that may be made. The assessment searches an optimization rules table (e.g., as shown in FIG. 8B) using the identity of the deployed device as an index to locate/find relevant (i.e., corresponding) sustainability optimization rules that can be applied to the deployed device. The assessment compares the reported device utilization (e.g., interfaces/ports have been inactive for more than 24 hours) against the optimization rules (e.g., interfaces/ports inactive for more than 24 hours) to determine whether there is a match, i.e., whether the reported device utilization meets a condition specified of one of the optimization rules (referred to as the “matching optimization rule”). When no match exists, flow returns to process the next telemetry record/deployed device.

On the other hand, when a match exists, the assessment determines a device command/actionable event corresponding to the matching optimization rule and that may be deployed to implement an operational configuration change (e.g., place the interfaces/ports into the sleep mode) of the deployed device to improve power savings. In other words, the operational configuration change is configured to place the deployed device into a more energy efficient mode.

In an example, the device command/actionable event may be listed along with the found/matching optimization rule, in which case the matching optimization rule identifies the device command. Optionally, the assessment sends to the deployed device the device command to reconfigure the deployed device accordingly (e.g., to place interfaces/ports to sleep). When implemented by the deployed device, the command transforms the (current) operational configuration of the deployed device to a more energy efficient transformed operational configuration, which improves sustainability. An example of a configuration change command for a deployed switch device is shown below:
Configure terminal,
Interface interface-id,
Power inline {auto [max max-wattage]|never|static [max max-wattage]}.

Once the above-mentioned power saving operational configuration transformation has been determined/generated/implemented, an indication of the operational configuration transformation is included in a power saving report along with potential energy gains that can be achieved by incorporating the changes. Flow proceeds to process the next telemetry record/deployed device.

At 312, the assessment searches equipment master 120 for a next gen device to replace the deployed device (i.e., to determine whether a next gen device is available for the deployed device). When a next gen device is not found, flow proceeds to 310, where optimization rule checks are performed as described above, and then flow returns to process the next telemetry record/deployed device. When a next gen device is found, flow proceeds to 314.

At 314, the assessment prepares to compute sustainability parameters for reduced ESG (i.e., ESG savings) based on a workload ratio associated with the deployed device and the next gen device, as stored in equipment master 120. Multiple previous passes through the assessment may have identified (i) a deployed number of units of the deployed device in equipment infrastructure 102 (e.g., 4 instances of a router of a particular type), and (ii) a workload ratio 1:N (where N>1) that equates N units of the deployed device to 1 unit of the next gen device based on equivalent computational power. In other words, the workload ratio 1:N indicates that 1 unit of the next gen device can perform equal work to N units of the deployed device. Thus, the assessment may recommend to replace N units of the deployed device with 1 unit of the next gen device. More generally, the assessment may recommend to replace the deployed number of units of the deployed device with a replacement number (i.e., a reduced number) of units of the next gen device that is less than the deployed number, according to: replacement number=deployed number=N, which achieves a reduced quantity (i.e., quantity savings) equal to the difference between the two numbers. In this way, the assessment determines the replacement number of units by reducing the deployed number of units by a workload ratio that equates one unit of the replacement device to multiple units of the deployed device. Thus, in one example, the replacement number is less than the deployed number. In another example, the replacement number is equal to the deployed number.

Armed with the replacement number of units of the next gen device used to replace the deployed number of instances of the deployed device, flow proceeds to 316 and to 318.

At 316, the assessment computes the consolidated parameters for the reduced ESG. First, the assessment computes a reduced energy (i.e., an energy savings) that would result from replacing the deployed number of units of the deployed device with the replacement number of the next gen devices. To do this, the assessment (i) computes a total deployed energy consumed by (i.e., a total deployed energy consumption of) the deployed number of units of the deployed device based on (e.g., by totaling) the energy consumed per deployed device as conveyed in the telemetry records, (ii) computes a total replacement energy consumed by the replacement number of units of the next gen device based on (e.g., by totaling) the replacement energy consumed by each unit of the next gen device as indicated in equipment master 120, and (iii) computes the reduced energy as the difference between (i) and (ii).

Second, using the carbon footprint equation mentioned above or any other suitable energy-to-carbon footprint conversion calculator, the assessment computes a reduced carbon footprint (i.e., a carbon footprint reduction) that results from the reduced energy.

At 318, the assessment computes a reduced energy cost that would result from replacing the deployed number of units of the deployed device with the replacement number of the next gen devices. To do this, the assessment:
a. Uses the geolocation of the deployed device as provided in the telemetry record(s) as an index into energy provider master 122 to retrieve a unity energy cost for the geolocation from the energy provider master.
b. Computes a total deployed energy cost for the deployed number of units of the deployed device based on (e.g., by multiplying) the unit energy cost and the total deployed energy consumed by the deployed number of units of the deployed device.
c. Computes a total replacement energy cost of using the replacement number of units of the next gen device based on the unit energy cost and the total replacement energy consumed by the replacement number of the next gen device.
d. Computes the reduce energy cost as a difference between the totals of (b) and (c).

The assessment also computes the reduced brown energy based on the reduced energy from 318 and a ratio of brown fuel to green fuel used for energy production at the geolocation as indicated in energy provider master 122.

The assessment reports (e.g., to enterprise 104 and/or to another network accessible administrative portal) the above-listed outcomes, and additionally reports one or more of the geolocation, the identity of the deployed device, the identity of the replacement device, the deployed number of units of the device, and the replacement number of units of the replacement device, for example.

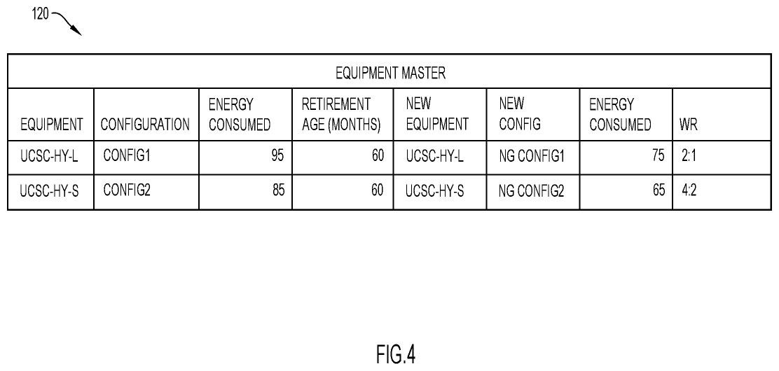

An example of sustainability operations 250 are described below in connection with FIGS. 4-8. FIG. 4 is an example of equipment master 120 in which each entry or row lists a vendor device (referred to as “equipment”) in terms of a model or part number, followed by a configuration of the vendor device (e.g., CPU, memory, cache, and speed information), an energy consumed by the vendor device, a retirement age of the vendor device, and a next gen device that can replace the vendor device. The next gen device is followed by a configuration of the next gen device, an energy consumed (i.e., a replacement energy consumed) by of the next gen device, and a workload ratio N:1, meaning 1 next gen device can do the work of N units of the vendor device.

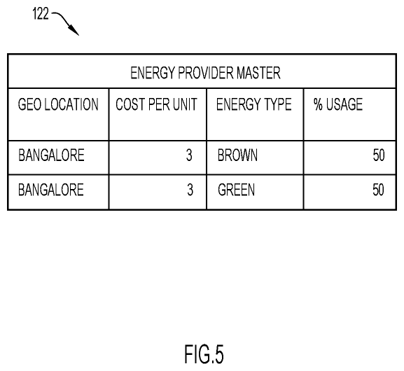

FIG. 5 is an example of energy provider master 122 in which each entry lists a geolocation, a unit energy cost (i.e., a cost per unit energy) in kWh per day (kWd) at the geolocation, an energy fuel type (e.g., brown or green), and a proportion (based on a ratio) of the energy that is produced using the energy fuel type.

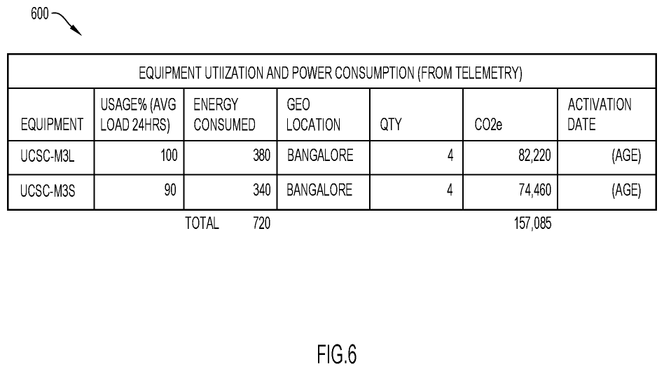

FIG. 6 is an example equipment utilization and power consumption table 600 (also referred to more simply as “table 600”) for deployed devices in equipment infrastructure 102. Table 600 is populated based on information from telemetry records from the deployed devices and computations made based on the information. In the example, the deployed devices listed in table 600 correspond to vendor devices listed in the first column of equipment master 120. Each entry of table 600 lists a deployed device followed by its usage, (actual) energy consumed, geolocation, quantity (i.e., deployed number of units of the deployed device), carbon footprint (CO2e), and activation date.

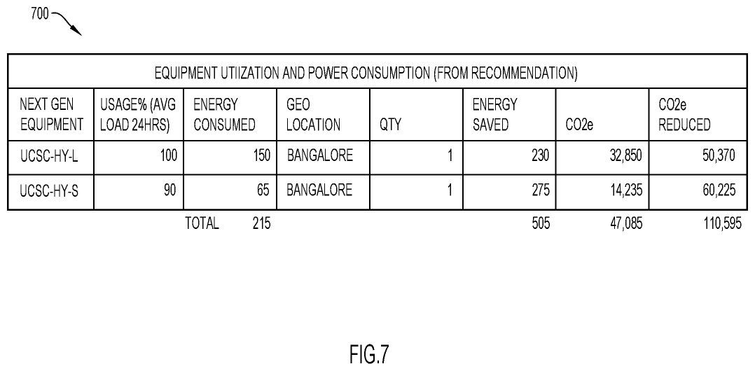

FIG. 7 is an example utilization and power consumption table 700 (also referred to more simply as “table 600”) for next gen devices, which equipment master 120 recommends as replacements for the deployed devices listed in table 600. Table 700 is populated using the information from equipment master 120 and energy provider master 122, as well as computation based on that information. Each entry of table 700 lists the next gen device (that replaces the deployed device) followed by its energy consumed, geolocation, quantity, reduced energy (i.e., energy saved) by using the next gen device in place of the device, carbon footprint, and reduced carbon footprint achieved were the replacement device to be used in place of the deployed device.

FIG. 8A is an example outcome table 800 that lists computed outcomes including an equipment power efficiency 802 taken from the reduced energy shown in table 7, a reduced carbon footprint 804 taken from the reduced carbon footprint in the last column of table 7, total deployed energy consumed 806 taken from the deployed energy consumed shown in table 6, total replacement (new) energy consumed 808 taken from the replacement energy consumed shown in table 7, a total reduced brown fuel 810. Total reduced brown fuel 810 is a difference between (i) the brown fuel consumed by the deployed devices (proportion of 50% for brown fuel from energy provider master 122·total deployed energy from table 600), and (ii) the brown fuel consumed by the next gen devices (proportion of 50% for brown fuel from energy provider master 122·total replacement energy from table 700).

The outcomes may also include a reduced energy cost computed as described above.

FIG. 8B is an example optimization rules table 850 employed by the sustainability IC (also referred to above as the “assessment”) to determine and optionally implement operational configuration transformations. Each entry or row lists a vendor device (referred to as “equipment”) in terms of a model or part number, a rule ID, a rule description, a device command (i.e., an actionable event), and an energy savings. The rule description defines a utilization threshold used by the sustainability IC to determine whether a sustainability gain can be achieved based on a comparison against actual deployed device utilization and workload. For example, the sustainability IC applies the rule when the actual device utilization is equal to or greater than (or, in other cases, less than) the utilization threshold. When the rule is applied, the sustainability IC may compute a sustainability gain using the “energy savings” factor applicable to the rule. The device command/actionable event indicates the operational configuration transformation to be applied.

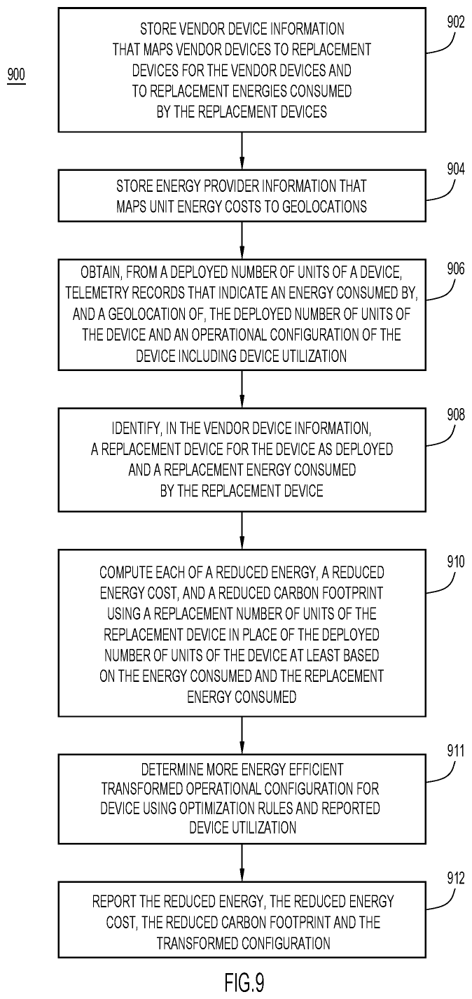

FIG. 9 is a flowchart of an example method 900 of performing an assessment of sustainability gains performed primarily by management entity 106. Operations of method 900 are described above.

At 902, the management entity stores vendor device information that maps vendor devices to replacement devices for the vendor devices and to replacement energies consumed by the replacement devices.

At 904, the management entity stores energy provider information that maps unit energy costs to geolocations.

At 906 the management entity obtains, from a deployed number (e.g., one or more) units of a device (i.e., a deployed device), telemetry records that indicate an energy consumed by, and a geolocation of, the deployed number of units of the device, and information defining an operational configuration of the device, including a utilization of the device. The device is part of an equipment infrastructure including compute, storage, and network devices.

At 908, the management entity identifies, in the vendor device information, a replacement device for the device as deployed and a replacement energy consumed by the replacement device.

At 910, the management entity computes sustainability gains including each of a reduced energy, a reduced energy cost, and a reduced carbon footprint of using a replacement number of units of the replacement device in place of the deployed number of units of the device at least based on the energy consumed, the replacement energy consumed, and the geolocation.

At 911, the management entity determines a change to the operational configuration that would result in improved operating energy efficiency, and optionally commands the device to implement the change. To do this, the management entity:
a. Stores a table of optimization rules that map the vendor devices to device utilization rules and to device commands used to change operational configurations of the vendor devices to be more energy efficient when the optimization rules are met.
b. Determines that the utilization of the device matches one of the device utilization rules and a corresponding device (reconfiguration) command. The device command may be configured to place a subsystem of the device into a more energy efficient mode (e.g., to transition interfaces/ports from a fully enabled and operating mode to a sleep mode). In addition, the management entity computes (or performs a lookup) of the potential energy savings.
c. Optionally commands the device to make the change using the corresponding device command. This transforms the operational configuration to a more energy efficient transformed operational configuration.

At 912, the management entity reports the sustainability gains including at least the reduced energy, the reduced energy cost, and the reduced carbon footprint for use in computing an ESG score for the equipment infrastructure. The management entity also reports the change to the operational configuration.

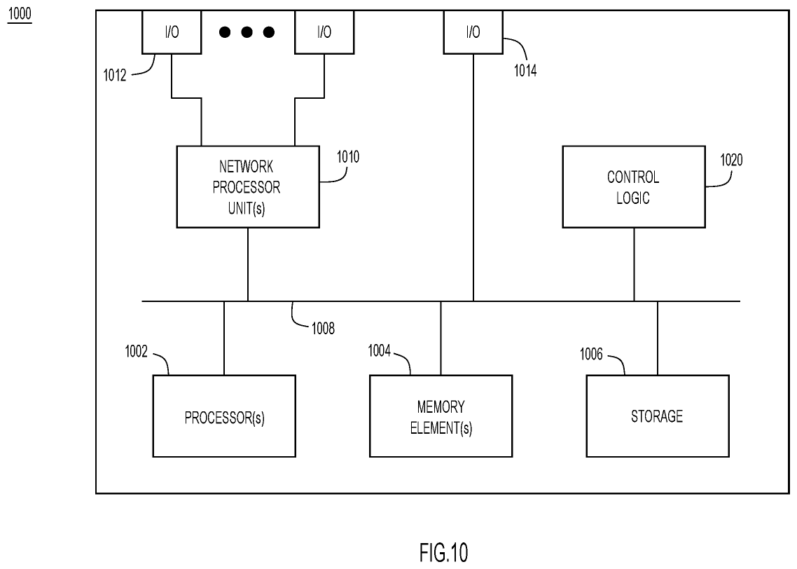

Referring to FIG. 10, FIG. 10 illustrates a hardware block diagram of a computing device 1000 that may perform functions associated with operations discussed herein in connection with the techniques depicted in FIGS. 1-9. In various embodiments, a computing device or apparatus, such as computing device 1000 or any combination of computing devices 1000, may be configured as any entity/entities as discussed for the techniques depicted in connection with FIGS. 1-9 in order to perform operations of the various techniques discussed herein. For example, computing device 1000 may represent management entity 106.

In at least one embodiment, the computing device 1000 may be any apparatus that may include one or more processor(s) 1002, one or more memory element(s) 1004, storage 1006, a bus 1008, one or more network processor unit(s) 1010 interconnected with one or more network input/output (I/O) interface(s) 1012, one or more I/O interface(s) 1014, and control logic 1020. In various embodiments, instructions associated with logic for computing device 1000 can overlap in any manner and are not limited to the specific allocation of instructions and/or operations described herein.

In at least one embodiment, processor(s) 1002 is/are at least one hardware processor configured to execute various tasks, operations and/or functions for computing device 1000 as described herein according to software and/or instructions configured for computing device 1000. Processor(s) 1002 (e.g., a hardware processor) can execute any type of instructions associated with data to achieve the operations detailed herein. In one example, processor(s) 1002 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 1004 and/or storage 1006 is/are configured to store data, information, software, and/or instructions associated with computing device 1000, and/or logic configured for memory element(s) 1004 and/or storage 1006. For example, any logic described herein (e.g., control logic 1020) can, in various embodiments, be stored for computing device 1000 using any combination of memory element(s) 1004 and/or storage 1006. Note that in some embodiments, storage 1006 can be consolidated with memory element(s) 1004 (or vice versa), or can overlap/exist in any other suitable manner.

In at least one embodiment, bus 1008 can be configured as an interface that enables one or more elements of computing device 1000 to communicate in order to exchange information and/or data. Bus 1008 can be implemented with any architecture designed for passing control, data and/or information between processors, memory elements/storage, peripheral devices, and/or any other hardware and/or software components that may be configured for computing device 1000. In at least one embodiment, bus 1008 may be implemented as a fast kernel-hosted interconnect, potentially using shared memory between processes (e.g., logic), which can enable efficient communication paths between the processes.

In various embodiments, network processor unit(s) 1010 may enable communication between computing device 1000 and other systems, entities, etc., via network I/O interface(s) 1012 (wired and/or wireless) to facilitate operations discussed for various embodiments described herein. In various embodiments, network processor unit(s) 1010 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 1000 and other systems, entities, etc. to facilitate operations for various embodiments described herein. In various embodiments, network I/O interface(s) 1012 can be configured as one or more Ethernet port(s), Fibre Channel ports, any other I/O port(s), and/or antenna(s)/antenna array(s) now known or hereafter developed. Thus, the network processor unit(s) 1010 and/or network I/O interface(s) 1012 may include suitable interfaces for receiving, transmitting, and/or otherwise communicating data and/or information in a network environment.

I/O interface(s) 1014 allow for input and output of data and/or information with other entities that may be connected to computing device 1000. For example, I/O interface(s) 1014 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 1020 can include instructions that, when executed, cause processor(s) 1002 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1020) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 1004 and/or storage 1006 can store data, software, code, instructions (e.g., processor instructions), logic, parameters, combinations thereof, and/or the like used for operations described herein. This includes memory element(s) 1004 and/or storage 1006 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### VARIATIONS AND IMPLEMENTATIONS

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X. Y or Z’, ‘one or more of X, Y and Z’, ‘one or more of X. Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’ (s)′ nomenclature (e.g., one or more element(s)).

In summary, in some aspects, the techniques described herein relate to a method including: at a management entity configured to communicate with a network: storing vendor device information that maps vendor devices to replacement devices for the vendor devices, and replacement energies consumed by the replacement devices; storing energy provider information that maps unit energy costs to geolocations; obtaining, from a deployed number of units of a device over the network, telemetry records that indicate an energy consumed by, and a geolocation of, the deployed number of units, and information defining an operational configuration of the device; identifying, in the vendor device information, a replacement device for the device and a replacement energy consumed by the replacement device; computing sustainability gains using a replacement number of units of the replacement device in place of the deployed number of units of the device at least based on the energy consumed, the replacement energy consumed, and the geolocation; determining a change to the operational configuration that would result in improved operating energy efficiency, and commanding the device to implement the change; and reporting the sustainability gains and the change to the operational configuration.

In some aspects, the techniques described herein relate to a method, wherein: computing the sustainability gains includes computing a reduced energy, a reduced energy cost based on the reduced energy and a unit energy cost at the geolocation as indicated in the energy provider information, and a reduced carbon footprint based on the reduced energy cost; and reporting includes reporting the reduced energy, the reduced energy cost, and the reduced carbon footprint.

In some aspects, the techniques described herein relate to a method, further including: determining the replacement number of units by reducing the deployed number of units by a workload ratio that equates one unit of the replacement device to multiple units of the device.

In some aspects, the techniques described herein relate to a method, wherein the replacement devices are more energy and computationally efficient than the vendor devices, and the replacement device is more energy and computationally efficient than the device.

In some aspects, the techniques described herein relate to a method, wherein: storing the vendor device information includes storing the vendor device information to further map the vendor devices to device utilization rules and to device commands used to change operational configurations of the vendor devices to be more energy efficient; obtaining includes obtaining the telemetry records to include the operational configuration for the device, including utilization of the device; determining the change includes determining that the utilization of the device matches one of the device utilization rules and a corresponding device command; and commanding includes commanding the device using the corresponding device command.

In some aspects, the techniques described herein relate to a method, wherein the vendor device information further maps the device to a retirement age for the device, the telemetry records further indicate an activation date of the device, and the method further includes: upon determining that the device is due to retire based on the activation date and the retirement age, performing computing the sustainability gains.

In some aspects, the techniques described herein relate to a method, further including: upon determining that the device is due to retire, determining the change to the operational configuration.

In some aspects, the techniques described herein relate to a method, wherein the energy provider information is further configured to map green fuel to brown fuel ratios for energy production at the geolocations, and the method further includes: computing a reduced brown fuel achieved using the deployed number of units of the replacement device in place of the deployed number of units of the device based on the green fuel to brown fuel ratio at the geolocation as indicated in the energy provider information.

In some aspects, the techniques described herein relate to a method, wherein: the vendor device information includes vendor identities for the vendor devices; the telemetry records include an identity for the device; and identifying includes searching the vendor identities for a match to the identity for the device.

In some aspects, the techniques described herein relate to a method, wherein: reporting further includes reporting the geolocation, the identity for the device, an identity of the replacement device, the deployed number of units of the device, and the replacement number of units of the replacement device.

In some aspects, the techniques described herein relate to a method, further including: establishing a telemetry feed with the deployed number of units of the device over a network, wherein obtaining includes receiving the telemetry records from the deployed number of units of the device over the telemetry feed.

In some aspects, the techniques described herein relate to an apparatus including: one or more network processor units to communicate over a network; and a processor coupled to the one or more network processor units and configured to perform: storing vendor device information that maps vendor devices to replacement devices for the vendor devices, and replacement energies consumed by the replacement devices; storing energy provider information that maps unit energy costs to geolocations; obtaining, from a deployed number of units of a device over the network, telemetry records that indicate an energy consumed by, and a geolocation of, the deployed number of units, and information defining an operational configuration of the device; identifying, in the vendor device information, a replacement device for the device and a replacement energy consumed by the replacement device; computing sustainability gains using a replacement number of units of the replacement device in place of the deployed number of units of the device at least based on the energy consumed, the replacement energy consumed, and the geolocation; determining a change to the operational configuration that would result in improved operating energy efficiency, and commanding the device to implement the change; and reporting the sustainability gains and the change to the operational configuration.

In some aspects, the techniques described herein relate to an apparatus, wherein the processor is configured to perform: computing the sustainability gains by computing a reduced energy, a reduced energy cost based on the reduced energy and a unit energy cost at the geolocation as indicated in the energy provider information, and a reduced carbon footprint based on the reduced energy cost; and reporting by reporting the reduced energy, the reduced energy cost, and the reduced carbon footprint.

In some aspects, the techniques described herein relate to an apparatus, wherein the processor is further configured to perform: determining the replacement number of units by reducing the deployed number of units by a workload ratio that equates one unit of the replacement device to multiple units of the device.

In some aspects, the techniques described herein relate to an apparatus, wherein the replacement devices are more energy and computationally efficient than the vendor devices, and the replacement device is more energy and computationally efficient than the device.

In some aspects, the techniques described herein relate to an apparatus, wherein the processor is configured to perform: storing the vendor device information by storing the vendor device information to further map the vendor devices to device utilization rules and to device commands used to change operational configurations of the vendor devices to be more energy efficient; obtaining by obtaining the telemetry records to include the operational configuration for the device, including utilization of the device; determining the change by determining that the utilization of the device matches one of the device utilization rules and a corresponding device command; and commanding by commanding the device using the corresponding device command.

In some aspects, the techniques described herein relate to an apparatus, wherein the vendor device information further maps the device to a retirement age for the device, the telemetry records further indicate an activation date of the device, and the processor is further configured to perform: upon determining that the device is due to retire based on the activation date and the retirement age, performing computing the sustainability gains.

In some aspects, the techniques described herein relate to a non-transitory computer readable medium encoded with instructions that, when executed by a processor, causes the processor to perform: storing vendor device information that maps vendor devices to replacement devices for the vendor devices, and replacement energies consumed by the replacement devices; storing energy provider information that maps unit energy costs to geolocations; obtaining, from a deployed number of units of a device over a network, telemetry records that indicate an energy consumed by, and a geolocation of, the deployed number of units, and information defining an operational configuration of the device; identifying, in the vendor device information, a replacement device for the device and a replacement energy consumed by the replacement device; computing sustainability gains using a replacement number of units of the replacement device in place of the deployed number of units of the device at least based on the energy consumed, the replacement energy consumed, and the geolocation; determining a change to the operational configuration that would result in improved operating energy efficiency, and commanding the device to implement the change; and reporting the sustainability gains and the change to the operational configuration.

In some aspects, the techniques described herein relate to a non-transitory computer readable medium, wherein: the instructions to cause the processor to perform computing the sustainability gains include instructions to cause the processor to perform computing a reduced energy, a reduced energy cost based on the reduced energy and a unit energy cost at the geolocation as indicated in the energy provider information, and a reduced carbon footprint based on the reduced energy cost; and the instructions to cause the processor to perform reporting include instructions to cause the processor to perform reporting the reduced energy, the reduced energy cost, and the reduced carbon footprint.

In some aspects, the techniques described herein relate to a non-transitory computer readable medium, further including instructions to cause the processor to perform: determining the replacement number of units by reducing the deployed number of units by a workload ratio that equates one unit of the replacement device to multiple units of the device.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
at a management entity configured to communicate with a network:
storing vendor device information that maps vendor devices to replacement devices for the vendor devices, and replacement energies consumed by the replacement devices;
storing energy provider information that maps unit energy costs to geolocations;
obtaining, from a deployed number of units of a device over the network, telemetry records that indicate an energy consumed by, and a geolocation of, the deployed number of units, and information defining an operational configuration of the device;
identifying, in the vendor device information, a replacement device for the device and a replacement energy consumed by the replacement device;
computing sustainability gains using a replacement number of units of the replacement device in place of the deployed number of units of the device at least based on the energy consumed, the replacement energy consumed, and the geolocation;
determining a change to the operational configuration that would result in improved operating energy efficiency, and commanding the device to implement the change; and
reporting the sustainability gains and the change to the operational configuration.

2. The method of claim 1, wherein:
computing the sustainability gains includes computing a reduced energy, a reduced energy cost based on the reduced energy and a unit energy cost at the geolocation as indicated in the energy provider information, and a reduced carbon footprint based on the reduced energy cost; and
reporting includes reporting the reduced energy, the reduced energy cost, and the reduced carbon footprint.

3. The method of claim 1, further comprising:
determining the replacement number of units by reducing the deployed number of units by a workload ratio that equates one unit of the replacement device to multiple units of the device.

4. The method of claim 1, wherein the replacement devices are more energy and computationally efficient than the vendor devices, and the replacement device is more energy and computationally efficient than the device.

5. The method of claim 1, wherein:
storing the vendor device information includes storing the vendor device information to further map the vendor devices to device utilization rules and to device commands used to change operational configurations of the vendor devices to be more energy efficient;
obtaining includes obtaining the telemetry records to include the operational configuration for the device, including utilization of the device;
determining the change includes determining that the utilization of the device matches one of the device utilization rules and a corresponding device command; and
commanding includes commanding the device using the corresponding device command.

6. The method of claim 1, wherein the vendor device information further maps the device to a retirement age for the device, the telemetry records further indicate an activation date of the device, and the method further comprises:
upon determining that the device is due to retire based on the activation date and the retirement age, performing computing the sustainability gains.

7. The method of claim 6, further comprising:
upon determining that the device is due to retire, determining the change to the operational configuration.

8. The method of claim 1, wherein the energy provider information is further configured to map green fuel to brown fuel ratios for energy production at the geolocations, and the method further comprises:
computing a reduced brown fuel achieved using the deployed number of units of the replacement device in place of the deployed number of units of the device based on the green fuel to brown fuel ratio at the geolocation as indicated in the energy provider information.

9. The method of claim 1, wherein:
the vendor device information includes vendor identities for the vendor devices;
the telemetry records include an identity for the device; and
identifying includes searching the vendor identities for a match to the identity for the device.

10. The method of claim 9, wherein:
reporting further includes reporting the geolocation, the identity for the device, an identity of the replacement device, the deployed number of units of the device, and the replacement number of units of the replacement device.

11. The method of claim 1, further comprising:
establishing a telemetry feed with the deployed number of units of the device over a network,
wherein obtaining includes receiving the telemetry records from the deployed number of units of the device over the telemetry feed.

12. An apparatus comprising:
one or more network processor units to communicate over a network; and
a processor coupled to the one or more network processor units and configured to perform:
storing vendor device information that maps vendor devices to replacement devices for the vendor devices, and replacement energies consumed by the replacement devices;
storing energy provider information that maps unit energy costs to geolocations;
obtaining, from a deployed number of units of a device over the network, telemetry records that indicate an energy consumed by, and a geolocation of, the deployed number of units, and information defining an operational configuration of the device;
identifying, in the vendor device information, a replacement device for the device and a replacement energy consumed by the replacement device;
computing sustainability gains using a replacement number of units of the replacement device in place of the deployed number of units of the device at least based on the energy consumed, the replacement energy consumed, and the geolocation;
determining a change to the operational configuration that would result in improved operating energy efficiency, and commanding the device to implement the change; and
reporting the sustainability gains and the change to the operational configuration.

13. The apparatus of claim 12, wherein the processor is configured to perform:
computing the sustainability gains by computing a reduced energy, a reduced energy cost based on the reduced energy and a unit energy cost at the geolocation as indicated in the energy provider information, and a reduced carbon footprint based on the reduced energy cost; and
reporting by reporting the reduced energy, the reduced energy cost, and the reduced carbon footprint.

14. The apparatus of claim 12, wherein the processor is further configured to perform:
determining the replacement number of units by reducing the deployed number of units by a workload ratio that equates one unit of the replacement device to multiple units of the device.

15. The apparatus of claim 12, wherein the replacement devices are more energy and computationally efficient than the vendor devices, and the replacement device is more energy and computationally efficient than the device.

16. The apparatus of claim 12, wherein the processor is configured to perform:
storing the vendor device information by storing the vendor device information to further map the vendor devices to device utilization rules and to device commands used to change operational configurations of the vendor devices to be more energy efficient;
obtaining by obtaining the telemetry records to include the operational configuration for the device, including utilization of the device;
determining the change by determining that the utilization of the device matches one of the device utilization rules and a corresponding device command; and
commanding by commanding the device using the corresponding device command.

17. The apparatus of claim 12, wherein the vendor device information further maps the device to a retirement age for the device, the telemetry records further indicate an activation date of the device, and the processor is further configured to perform:
upon determining that the device is due to retire based on the activation date and the retirement age, performing computing the sustainability gains.

18. A non-transitory computer readable medium encoded with instructions that, when executed by a processor, causes the processor to perform:
storing vendor device information that maps vendor devices to replacement devices for the vendor devices, and replacement energies consumed by the replacement devices;
storing energy provider information that maps unit energy costs to geolocations;
obtaining, from a deployed number of units of a device over a network, telemetry records that indicate an energy consumed by, and a geolocation of, the deployed number of units, and information defining an operational configuration of the device;
identifying, in the vendor device information, a replacement device for the device and a replacement energy consumed by the replacement device;
computing sustainability gains using a replacement number of units of the replacement device in place of the deployed number of units of the device at least based on the energy consumed, the replacement energy consumed, and the geolocation;
determining a change to the operational configuration that would result in improved operating energy efficiency, and commanding the device to implement the change; and
reporting the sustainability gains and the change to the operational configuration.

19. The non-transitory computer readable medium of claim 18, wherein:
the instructions to cause the processor to perform computing the sustainability gains include instructions to cause the processor to perform computing a reduced energy, a reduced energy cost based on the reduced energy and a unit energy cost at the geolocation as indicated in the energy provider information, and a reduced carbon footprint based on the reduced energy cost; and
the instructions to cause the processor to perform reporting include instructions to cause the processor to perform reporting the reduced energy, the reduced energy cost, and the reduced carbon footprint.

20. The non-transitory computer readable medium of claim 18, further comprising instructions to cause the processor to perform:
determining the replacement number of units by reducing the deployed number of units by a workload ratio that equates one unit of the replacement device to multiple units of the device.
